(19) United States
(12) Patent Application Publication
(10) Pub. No.: US 2020/0122456 A1
(43) Pub. Date: Apr. 23, 2020

(54) MACHINE AND METHOD FOR SINGLE-PASS DIGITAL PRINTING ON GLASS

(71) Applicant: TECGLASS SL

(72) Inventors: Javier Fernandez Vazquez, Pontevedra (ES); Manuel Ramos Quiroga, Leon (ES)

(21) Appl. No.: 16/581,707

(22) Filed: Sep. 24, 2019

Related U.S. Application Data
(62) Division of application No. 15/777,050, filed on May 17, 2018.

(51) Int. Cl. B41J 2/045; B41J 2/155; B41J 3/407; B41J 25/00; B41J 2/21; B41J 3/28; C03C 17/00; B41J 2/515

(52) U.S. Cl. CPC B41J 2/0451; B41J 2/04586; B41J 2/155; B41J 3/407; B41J 25/001; C03C 2218/119; B41J 3/28; C03C 17/002; B41J 2/2146; B41J 2/515; B41J 2/2139

(57) ABSTRACT

The invention relates to a machine and method for single-pass digital printing on glass (1).

The machine comprises: a support structure (2) for securing the sheet of glass (1); and a printing bridge (3) which, during printing, can move along the longitudinal “X” axis of the support structure (2), said bridge supporting digital printing means (33) with print bars (100, 100′, 100″) comprising successive printing heads (10, 10′, 10″), as well as supporting a scanner (32) for capturing data relating to the positions of defects (X″, Y″).

### OBJECT OF THE INVENTION

The object of the present invention consists of a method and a machine for single-pass digital printing on glass, which employs digital printing heads, and which may also act as a multi-pass for the correction of printing defects detected after the printing, or to make prints of greater complexity.

### BACKGROUND OF THE INVENTION

In the state of the art of machines for digital printing on glass are frequent multi-pass machines comprising a print carriage that travels along a bridge located on the passage “X” of a glass sheet that is placed and moved on a table (see patent ES2.337.829T3), and said bridge (and therefore the displacement “Y” of the printing carriage) being transverse or perpendicular to passage “X” of the glass to be printed as described in patent ES2.396.532. Technology in which the bridge moves in the “X” direction (with traversal displacement “Y” of the printing carriage) while the glass is held in a fixed position is also known. In these cases, there is a printing carriage that has to print the glass in several passes with said carriage moving across the width of the bridge that supports it.

These machines are commonly called multi-pass, or multipass, since in general they print in the following way: the glass is placed in the printing position and the bridge moves in the “X” direction towards the glass (or glass moves “X” on the table until the part to be printed is under the bridge), the print carriage begins to move across the “Y” width of the bridge while printing on the glass (making a pass over the glass), then the glass, or bridge, moves in the “X” direction the width of the printing head and the carriage returns to make a printing in the “Y” direction and so on until finishing the printing on the glass to be printed. There are variants of multi-pass printing as described in patent EP2631077.

In short, the multi-pass process is a printing method by which the head performs several passes depending on the resolution to be achieved to perform the printing on the glass. The machines that execute this multi-pass method usually consist of a printing carriage with several printing heads, with dimensions less than the maximum format to be printed on the glass sheet and, therefore, the only way to cover the maximum format is making multiple passes on the glass sheet or matter to be printed. This number of passes, as already indicated, will be greater or lesser depending on the resolution that is intended to be achieved.

Multi-pass digital printing machines have economic advantages by using small printing carriages with few printing heads. Also, by executing multiple passes, they may be able to hide a printing defect produced by a head, since the failure of the first pass may be covered by a second pass (see patent document US2014/0204426).

On the contrary, these machines, from having to carry out several printing passes of the printing carriage, the printing time is prolonged proportionally to the number of passes to be executed.

The current printing machines that execute, on the contrary, single-pass digital printing processes in which the glass to be printed is moved under printing heads usually have a series of drawbacks:
In the event that the matter has already passed through the machine and some defect in the printing has occurred, it is no longer impossible to return it exactly through an identical path with the required precision to be able to correct the defect with a localized print on the identified defect. Therefore, the current single-pass machines usually leave any very evident printing defect. For example, in the industrial sector of ceramics, where the matter to be printed is opaque, the matter to be printed is usually moved, and hot printing occurs (over 40 degrees) and for limited dimensions (maximum 1.5×1.5 meters).
In order to single-pass print on glass is necessary a great precision in the positioning and systems that move the matter, which is highly complex.

### DESCRIPTION OF THE INVENTION

The machine and method object of the present invention overcomes the disadvantages of the multi-pass and single-pass printing machines described above.

The single-pass machine object of the present invention allows making several passes to correct any defect detected after a single-pass or to print any design that due to its complexity can not be made in single-pass. It acts as a mixed printing machine. When acting as a single-pass (or singlepass), the glass sheet to be printed is placed in the printing position by an automatic positioning. A printing bridge makes a pass (in the “X” direction) above the glass sheet, which is placed statically, printing all the glass upon completion of the pass. To do this, the bridge incorporates printing media along its width that cover the width of glass, or glass sheet, to be printed.

The advantage of this new single-pass machine and method is its high productivity, since it can print a glass sheet several times faster than the classic multi-pass machines. Another advantage is that it can print more precisely and accurately than the current single-pass printing machines, since the glass is positioned and static in an exactly known position.

When a defect has occurred during single-pass printing in the machine object of the present invention, since the glass is static and held in the printing position, said defects may be detected by graphic assistance means connected to a central processing and control unit of the printing machine that may instruct the bridge to perform additional high precision passes on the glass to correct the detected defects. These graphic assistance means can be of optical type installed in the printing machine (for example in the printing bridge) that analyze the printed image and detect defects.

Therefore, once the single-pass printing is performed, or even a single-pass for rectification of defects, the graphic assistance means performs a pass (for example a scanner located on the bridge that will give a scanning pass) on the printed glass, and if it does not detect defects (the scanner can take high-precision photographs of the printed glass) with respect to the reference or pattern to be printed, it activates the means for ejecting the glass from the machine. This operation may be semi-automated, so that the expulsion of the printed glass must wait for an operator confirmation, in case it is decided to opt for a manual inspection. That is, it may be an operator who, upon detecting a defect visually, activates a new printing pass before authorizing the evacuation or ejection of the glass from the machine, thus correcting the defect.

Therefore, the printing machine object of the present invention is a mixed printing machine that can work in single-pass, or multi-pass mode, if it is necessary to correct a detected defect or it is necessary to print a design of a certain complexity or precision that requires the machine to work in two or more passes. With this machine, a series of advantages are achieved:
Significant reduction of printing times of traditional multi-pass machines, providing a more productive alternative.
Flexibilization of high volume production systems. Today, large volume manufacturers often use printing screens that limit production flexibility due to the high costs of screen replacement. Using the machine object of the present invention, each glass sheet may be printed with a different design without affecting the cycle time, by means of the selection in the graphic assistant associated with the machine. In such graphical assistant the design to be printed may be chosen every time a new glass sheet enters the machine, even loading on-line from production servers the designs provided by the customer.

For example, the industry of manufacturers of serial automotive glass or glass for white goods (oven doors, kitchen countertops, etc.) may be passed, with this machine, to digital printing, gaining in flexibility.

More specifically, the single-pass digital printing machine on glass object of the present invention has: a support structure with automatic positioning means for positioning and securing a glass sheet during printing and with ejecting means of the glass sheet and also with glass transport means when the printing is not being produced, and also a printing bridge movable in the “X” direction located on said support structures, and digital printing means of the glass, or glass sheet, supported by said bridge.

The digital printing means consist of parallel bars with printing heads, with each bar preferably occupying the entire effective width of the bridge (i.e., the part of the bridge that remains over the areas of the support structure in which a glass sheet may be placed), and each printing bar having all its heads connected to an ink supply of the same colour.

Therefore, if successive printing bars are installed, they are installed in parallel. The printing heads of the printing means perform a controlled printing, by a central processing and control unit of the machine, continuously on the glass when said bridge moves (“X”) on the static glass secured by the means for fixing the glass during printing.

The digital printing machine object of the present invention incorporates graphics assistance means, connected to the central processing and control unit, for automatic detection and capture of the positions data of the printing defects (X″, Y″) on the glass sheet, and sending said data to a central data processing and control unit. These graphic assistance means can be, for example, optical scanners supported by the bridge. The machine may also incorporate artificial vision means for automatic capture and sending of the data of the outer perimeter (X, f(X)) of the glass sheet, said data being sent to the central data processing and control unit.

The central data processing and control unit of the machine consists of at least one module with the position data of the pattern (X′,Y′) or figure to be printed and its colours (C′(X′,Y′)), a module with the position data of the printing defects (X″, Y″) and their corresponding colours (C″(X″,Y″)) (which correspond to the pattern colours (C″(X″,Y″)=(C′(X′,Y′))) on the glass sheet (1), and optionally a module for receiving the data from said artificial vision means for automatic capture of the data from the outer perimeter of the glass sheet, a software for processing the data arriving at the central data processing and control unit, and determining the position information of the printing heads on the printing coordinates (X′,Y′), optionally a module for recognizing the perimeter of the glass sheet to avoid any printing outside the contours of the glass sheet, and a module for sending the printing signals to the heads of the printing means as a function of the pattern data ((X′,Y′), (X″,Y″)) and colours (C′,C″) to be printed on the glass sheet.

The digital printing method object of the present invention, with the machine object of the present invention, has a step of feeding, positioning and securing the glass in the printing plane, a step of complete and continuous movement of the printing bridge over the secured glass, with simultaneous printing of the printing heads which print a pre-selected pattern for each glass to be printed, printing only the heads of the printing bars that are placed on the glass (1) according to the colour (C′(X′,Y′)) and position (X′, Y′) data of the figure to be printed supplied by the central processing unit. The information that the printing heads have to print can also be provided by the file itself to be printed that can be sent by the client that makes the order.

In addition, the method may be executed with a step of detecting the position data of printing defects (X″, Y″) on the glass sheet (for example, by scanning performed by a scanner located on the printing bridge) at the end of each printing pass, followed by at least one step of complete and continuous displacement of the printing bridge on the secured glass, with simultaneous and selective printing of the printing heads that print on the defects (X″, Y″) detected in the glass and according to the corresponding colour data (C″(X″,Y″)).

Also, the machine object of the present invention may incorporate, together with the printing heads, devices for drying the ink printed on the glass surface with, for example, laser and/or infrared lamp technology. Said drying devices are controlled by the central processing and control unit, which is configured by associating the printing signal of each head with a signal for activating the drying means associated with said head.

The machine object of the present invention may employ a series of common components in machines such as motors, electronics, electricity and pneumatics known in the state of the art.

By using commercial ink heads that also use commercial printing inks (for example, the printing head may be of the type of DROP-ON-DEMAND technology), it lowers the maintenance and operation costs of the machine, providing great flexibility in the supply of key components and cost savings.

If the printing heads and the drying lasers and/or infrared lamps are put together, the laser and/or infrared lamp is covered and dried throughout the width of the printing with each pass of the bridge over the glass surface. Thus, the heads deposit the ink and immediately, and simultaneously, the laser beam and/or the infrared lamp dry the deposited ink.

The method object of the invention, therefore, also allows a single step of (single-pass) digital printing with simultaneous drying of the print by the simultaneous laser and/or infrared lamp fixed to each printing head, of defect correction by means of multi-passes of the bridge and of printing of very complex designs in multi-pass, and optionally also a step of final tempering of the glass with vitrification of the applied ink.

### BRIEF DESCRIPTION OF THE DRAWINGS

The following figures are included in order to facilitate the understanding of the invention:

FIG. 1: perspective view of the printing machine object of the present invention.

FIG. 2: bottom plan view of the bridge with the printing and scanning means.

### PREFERRED EMBODIMENT OF THE INVENTION

Next, a preferred embodiment of the machine object of the present invention is detailed.

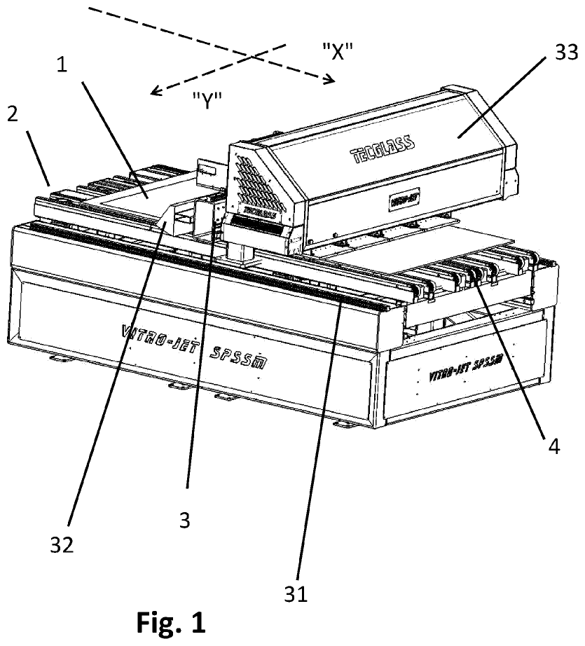

FIG. 1 shows a single-passed digital printing machine on glass with a support structure (2) having automatic positioning means for the positioning and securing (not shown) of a glass sheet (1) and with transport means, (4) by belts, of the glass sheet when printing is not occurring. The printing bridge (3) moves along the guides (31) supported on the sides of the support structure (2) in the “X” direction (longitudinal axis of the machine) and supports digital printing means (33) and a scanner (32) for detecting the defect positions (X″, Y″) on the “X” and “Y” axes of the machine.

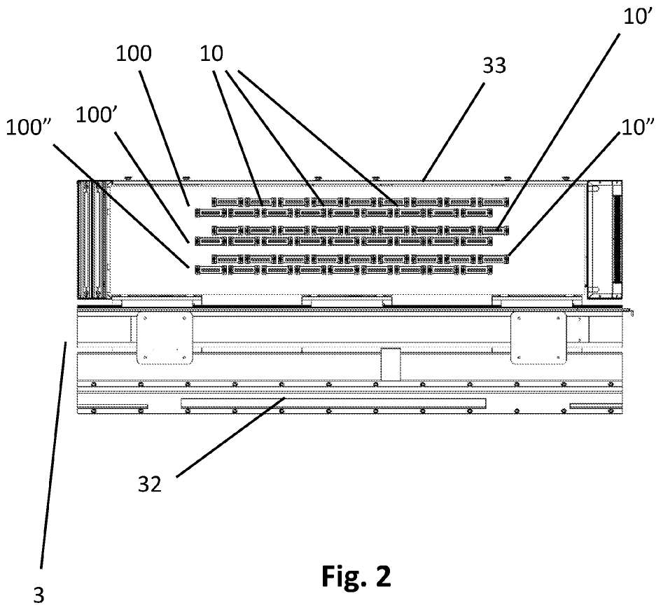

As seen in FIG. 2, the bridge (3) supports digital printing means (33) of the glass sheet (1) with six printing bars (for example references 100, 100′ and 100″ in FIG. 2) parallel in their lower part, which occupy the entire effective width (between the lateral guides (31)) of the bridge (3). Each bar has a succession of printing heads (for example, references 10, 10′ and 10″ in FIG. 2) that incorporate DROP-ON-DEMAND technology.

1. Machine for single-pass digital printing on glass (1) characterised in that it comprises:
a. a support structure (2) comprising means configured for the positioning and automatic securing of a glass sheet (1) during printing, and means configured for the transport (4) of said glass sheet,
b. a printing bridge (3) configured to move along the longitudinal “X” axis of the support structure (2) and located on said supporting structure, and
c. digital printing means (33) of the glass sheet, supported by said bridge (3) configured to perform the printing on the glass sheet (1) when said bridge (3) moves on the glass sheet secured to said structure support (2); said printing means comprising at least one printing bar (100), said printing bar comprising successive printing heads (10), and said successive printing heads (10) of each printing bar (100) being fed by ink of the same colour.

2. Method for single-passed digital printing on glass executed by the machine of claim 1, characterised in that it comprises:
a. A step of feeding, positioning and securing the glass sheet (1) in the printing plane, and
b. A step of complete and continuous movement of the printing bridge (3) on the statically secured glass sheet, with simultaneous printing of the printing heads (10, 10′, 10″) that print a selected pattern on the glass, printing only the heads of the printing bars that are placed on the glass (1) as a function of the position data (X′, Y′) of the figure to be printed and colour data (C(X′,Y′)).

3. Method for digital printing according to claim 1 characterised in that it further comprises:
a. a step of detecting the position data of the printing defects (X″, Y″) on the glass sheet (1), and
b. at least one step of complete and continuous movement of the printing bridge on the fixed glass, with simultaneous and selective printing of the printing heads that print on the defect positions (X″, Y″) detected on the glass.

4. Method for digital printing according to claim 2, characterised in that said digital printing step occurs simultaneously with a step of drying the ink by emitting radiation for drying the ink.

5. Method for digital printing on glass, according to claim 2, characterised in that it further comprises a step of final tempering for the vitrification of the ink.

6. Method for digital printing according to claim 3, characterised in that said digital printing step occurs simultaneously with a step of drying the ink by emitting radiation for drying the ink.
